(19) United States
(12) Patent Application Publication
(10) Pub. No.: US 2008/0295576 A1
(43) Pub. Date: Dec. 4, 2008

(54) GAS SENSOR HAVING INSULATOR ASSEMBLY FOR SUPPORTING HEATER

(75) Inventor: Masanobu Yamauchi, Kariya-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/132,778

(22) Filed: Jun. 4, 2008

(30) Foreign Application Priority Data
Jun. 4, 2007 (JP) 2007-148098

(51) Int. Cl. G01N 27/00

(52) U.S. Cl. 73/23.31

(57) ABSTRACT

There is provided a gas sensor that includes a sensor element, a heater that comprises an electrode, a housing that holds the sensor element therein, an insulator assembly that surrounds a part of the heater and is constituted of a plurality of insulators, an electric terminal member that is located between the one of the plurality of the insulators and the electrode of the heater, a cover that covers the insulator assembly, a holder for holding the insulator assembly, and an elastic member that is located between the holder and the cover to generate elastic force which is applied at least to the one of the plurality of the insulators to pinch the heater between the one and another one of the plurality of the insulators via the holder so as to bring the electric terminal member into constant electric contact with the electrode of the heater.

### CROSS REFERENCE TO RELATED APPLICATION

The present application relates to and incorporated by reference Japanese Patent Application No. 2007-148098 filed on Jun. 4, 2007.

### BACKGROUND OF THE INVENTION

1. The Field of the Invention

The present invention relates to a gas sensor for determining the concentration of a specific gas component contained in a measurement gas to be measured, for example, a gas sensor located in an exhaust system of a vehicle-mounted internal combustion engine for determining a specific gas component in an exhaust gas emitted from the engine

2. Description of the Related Art

In most automobiles, exhaust systems are employed by internal combustion engines, in which the exhaust systems includes a gas sensor installed on an exhaust gas flow passage of the internal combustion engine with a view to determining the concentration of a specific gas component in an exhaust gas emitted from the internal combustion engine (hereinafter, it is sometimes abbreviated as “engine” for simplicity) for, performing combustion control of the internal combustion engine for example, oxygen, nitrogen oxide and others.

Yamada et al. disclose an example of such gas sensors in Japanese Patent Laid-open (unexamined) No. 2004-144732. The gas sensor of Yamada et al. is installed in an exhaust pipe or other devices such that a side of the gas sensor referred to as a “distal end side” or “measurement gas side” is inserted into the exhaust pipe or the other devices. The opposite side to the distal end side is referred to as a “base end side” or “atmosphere side”. The gas sensor comprises a sensor element that determines the concentration of a specific gas component contained in a measurement gas, a heater that heats up the sensor element and surrounds the sensor element, a housing which allows a sensor element to be inserted and held therein, a measurement gas side cover that is disposed at a distal end section of the housing to caver a distal end section of the sensor element in a longitudinal axis of the gas sensor, and an atmosphere side cover that is jointed to a base end of the housing. The gas sensor is provided with an atmosphere side insulator that is disposed at a base end section of the housing to cover a base end section of the heater. The atmosphere side insulator further comprises a plurality of pinching members to cover and pinch a base end section of the heater via a terminal spring. The terminal spring is positioned between the pinching member and the base end section of the heater, and fixes the base end section of the heater inside the atmosphere side insulator. The gas sensor is further provided with a pressing spring comprising a main body with which the atmosphere side insulator is bound and which holds and engages the pinching members to form the atmosphere side insulator, and a fixing piece which is formed at a distal end section of the body of the pressing spring and presses an inner peripheral surface of the atmosphere side cover to maintain the pinching members such that the base end section of the heater is appropriately positioned inside the atmosphere side cover. The pressing spring is made of either a metal or another elastic material. The fixing piece of the pressing spring generates a pressure force towards a radial direction in a plane perpendicular to the longitudinal axis of the gas sensor to press the inner peripheral surface of the atmosphere side cover when the atmosphere side insulator is positioned inside the atmosphere side cover after the atmosphere side insulator and the pressing spring are integrated. The pressing spring ensures to fix the atmosphere side insulator to an appropriate position inside the atmosphere side cover so that the position of the atmosphere side insulator does not easily shift.

However, in the gas sensor of Yamada et al., the pressing force generated by the fixing piece of the pressing spring is only utilized to fix the atmosphere side insulator to a position inside the atmosphere side cover. Hence, it is necessary to provide the atmosphere side insulator with a terminal spring to hold the heater and thus the sensor element. The terminal spring is made of a conductor in which electric current can flow. Thus, when an electric terminal of the heater is formed on a surface of the base end section of the heater and electric power is supplied to the terminal spring from an external electric supply, the terminal spring not only presses and fixes the heater, but also serves as an electric wire for transferring electric power to the heater. Thus, the gas sensor of Yamada et al. includes not a small number of springs or members generating pressing force which results in a mechanically complicated supporting structure of the heater and the sensor element in the atmosphere side cover, and the number of the constituents of the gas sensor is increased.

Further, Weyl et al. disclose a gas sensor, in U.S. Pat. No. 5,246,562, which includes an axially oriented sensor having an elongated, planar shape in the longitudinal bore of a metallic housing. The sensor has a distal end section having at least one sensor element and possibly heating element, and a base end section that on a connecting side of the planar sensor is provided with layered contact surfaces being in contact with the sensor element and/or the heating element provided at the distal end section via a strip conductor. A connector plug surrounding the sensor on the connecting side consists of a contact element support, an opposite wall, contact elements, and an annularly-shaped spring element. Due to its mechanical pre-stressing, the spring element presses the contacting elements of the contact support and of the opposite wall against the layered contact surfaces of the sensor. The connector plug allows installation on the layered contact surfaces and possible coatings on the contact element of the connector plug. The gas measurement sensor of Weyl et al. has an advantage: in the course of assembly of the sensor element and the connecting plug on the connecting side, neither the contact surfaces of the sensor nor possible corrosion-resistance coatings on the contact elements are damaged so that impairment of the gas measurement sensor is improved. While the connector plug, the base end section of the sensor are assembled by using the spring element and are covered by a metal sleeve, these are not connected to the metal sleeve. Hence when the gas measurement sensor receives vibration from the outside, the elongated, planar gas sensor may be broken because the connector plug and the spring element cause an unbalance of distribution of mass.

### SUMMARY OF THE INVENTION

The present invention has been made taking the above mentioned problems into consideration, an object of the present invention is to provide a gas sensor having a holder that is capable of holding an insulator therein and ensuring that a heater electrode formed on a surface of a heater contacts and a sensor electrode formed in a surface of a sensor element with electrode contact members so that it is possible to prevent the gas sensor from being broken even if the gas sensor receives vibration from the outside and to provide reliable electric contact between the heater electrode formed on the surface of the heater and one of the electrode contact member and between the sensor electrode and another electrode contact member.

According to a first aspect of the present invention, there is provided a gas sensor that has a base end and a distal end opposite to the base end along a center axis of the gas sensor, and has a sensor element, a heater, a housing, an insulator assembly, an electric terminal member, a cover, a holder, and an elastic member. The sensor element produces a signal indicating a concentration of a gas. The heater heats up the sensor element and has a length having a base end nearer to the base end of the gas sensor than the distal end of the gas sensor along the center axis of the gas sensor. The heater further comprises a base end section that is located near the base of the heater and an electrode that is disposed on an peripheral surface of the base end section. The housing has a base end nearer to the base end of the gas sensor than the distal end of the gas sensor and a through-hole in which the sensor element is held. The insulator assembly surrounds the base section of the heater and is constituted of a plurality of insulators. The electric terminal member is located between the one of the plurality of the insulators and the electrode of the heater. The cover covers the insulator assembly and has an inner wall surface. The holder is configured to hold the insulator assembly and is arranged between the insulator assembly and the cover. The elastic member is located between the holder and the inner wall surface of the cover to generate elastic force which is applied at least to the one of the plurality of the insulators to pinch the heater between the one of the one of the plurality of the insulators and another one of the plurality of the insulators via the holder so as to bring the electric terminal member into constant electric contact with the electrode of the heater.

Therefore, Thus, when the number of the elastic members and positions at which the elastic members to be arranged so that the pressing force is adjusted to have an appropriate strength and direction by changing the number of the elastic members and/or the positions at which the elastic members to be arranged, the electrode of the heater is ensured to be in contact with the electric terminal member and to fix the insulator assembly to an appropriate position inside the cover without any complicated structures of the constituents of the gas sensor.

According to a second aspect of the present invention, there is provided a gas sensor that has the sensor element, the heater, the housing, the insulator assembly, the electric terminal member, the cover, the holder, and the elastic member, wherein the insulator assembly includes two insulators. The two insulators 50 are easily bounded or engaged with each other.

According to a third aspect of the present invention, there is provided a gas sensor that has the sensor element, the heater, the housing, the insulator assembly, the electric terminal member, the cover, the holder, and the elastic member, wherein the electric terminal member in the gas sensor has been formed to generate no restoring force. Hence, it is allowed that the electric terminal member can be made of a material having no elasticity. Thus, the electric terminal member and thus the gas sensor have cost advantages.

According to a fourth aspect of the present invention, there is provided a method for manufacturing a gas sensor that has the sensor element, the heater, the housing, the insulator assembly, the electric terminal member, the cover, the holder, and the elastic member, includes steps of: locking the electric terminal member to the one of the plurality of the insulators, pinching the heater between the one of the one of the plurality of the insulators and another one of the plurality of the insulators so as to bring the electric terminal member into constant electric contact with the electrode of the heater, forming the insulator assembly from the one of the plurality of the insulators and another one of the plurality of the insulators so that the insulator assembly holds the heater therein, disposing the elastic member on a surface of the holder, inserting the elastic member and the holder surrounding the insulator assembly in which the heater is held to an inside space of the cover such that the elastic force generated by the elastic member is applied at least to the one of the plurality of the insulators to pinch the heater between the one of the plurality of the insulators and another one of the plurality of the insulators via the holder and applied to the holder to fix the insulator assembly inside the cover. Hence, in the course of assembly, the electrode of the heater would not be damaged so that impairment of the gas sensor is prevented.

According to a fifth aspect of the present invention, there is provided a gas sensor that has the sensor element, the heater, the housing, the insulator assembly, the electric terminal member, the cover, and a holder. The holder is arranged between the insulator assembly and the inner wall surface of the cover, and has means for holding the insulator assembly and means for generating elastic force which is applied at least to the one of the plurality of the insulators to pinch the heater between the one of the one of the plurality of the insulators and another one of the plurality of the insulators via the holder so as to bring the electric terminal member into constant electric contact with the electrode of the heater.

According to a sixth aspect of the present invention, there is provided a method for manufacturing a gas sensor that has the sensor element, the heater, the housing, the insulator assembly, the electric terminal member, the cover, and the holder which is arranged between the insulator assembly and the inner wall surface of the cover, and has means for holding the insulator assembly and means for generating elastic force which is applied at least to the one of the plurality of the insulators to pinch the heater between the one of the plurality of the insulators and another of the plurality of the insulators via the holder so as to bring the electric terminal member into constant electric contact with the electrode of the heater, includes steps of: locking the electric terminal member to the one of the plurality of the insulators, pinching the heater between the one of the one of the plurality of the insulators and another one of the plurality of the insulators so as to bring the electric terminal member into constant electric contact with the electrode of the heater, forming the insulator assembly from the one of the plurality of the insulators and another one of the plurality of the insulators so that the insulator assembly holds the heater therein, inserting the holder surrounding the insulator assembly in which the heater is held to an inside space of the cover such that the elastic force is applied at least to the one of the plurality of the insulators to pinch the heater between the one of the plurality of the insulators and another one of the plurality of the insulators via the holder and applied to the holder to fix the insulator assembly inside the cover. Hence, in the course of assembly, the electrode of the heater would not be damaged so that impairment of the gas sensor is prevented.

### BRIEF DESCRIPTION OF THE DRAWINGS

The present invention will be understood more fully from the detailed description to be given hereinbelow and from the accompanying drawings of the preferred embodiment of the invention, which is not taken to limit the invention to the specific embodiments but should be recognized for the purpose of explanation and understanding only.

In the drawings:

FIG. 1 is an axial (longitudinal) cross-sectional view showing an overall structure of a gas sensor according to a first embodiment of the present invention;

FIG. 2 is an axial (longitudinal) cross-sectional view showing the overall structure of the gas sensor taken on line A-A of FIG. 1;

FIG. 3 is an enlarged partial cross-sectional view showing a supporting structure of a heater and an atmosphere-side insulator assembly, the supporting structure including the heater, the atmosphere-side insulator, an electrode contact member, a holder, and an atmosphere-side cover;

FIG. 4 is a cross-sectional view, taken along a planar direction perpendicular to a longitudinal direction of the gas sensor, showing the heater, the atmosphere-side insulator assembly which is formed to be engaged by a plurality of atmosphere-side insulators and a holder that has a spring and partially surrounds the atmosphere-side insulator assembly, wherein the heater is pressed by pressing force generated by the spring via the atmosphere-side insulators;

FIG. 5 is a perspective view showing the holder that has a fixing spring generating the pressing force towards a radial direction in a plane perpendicular to the longitudinal direction of the gas sensor;

FIG. 6 is a perspective view showing one of the atmosphere-side insulators having an electrode fixing portion to which the electrode contact member is fitted;

FIG. 7 is an enlarged axial (longitudinal) sectional view showing the heater, the holder, and the electrode contact member, wherein each of the heater electrodes of the heater is in contact with the electrode contact member running a length L;

FIG. 8 is a cross-sectional view, taken on a line B-B in FIG. 7, showing the heater and the electrode contact member;

FIG. 9 is a perspective view showing the electrode contact member;

FIG. 10 is a perspective view showing steps of assembly of the heater, the heater electrodes, and the electrode contact member, wherein the electrode contact member is fitted to the electrode fixing portion of the atmosphere-side insulator, and two atmosphere-side insulators are engaged each other to form the atmosphere-side insulator assembly;

FIG. 11 is a perspective view showing steps of assembly of the atmosphere-side insulator assembly, the holder, and the atmosphere-side cover;

FIG. 12 is an axial (longitudinal) sectional view showing an overall structure of a comparative gas sensor;

FIG. 13 is a perspective view showing atmosphere-side insulators, terminal springs, a heater, and pinching members, wherein one of the pinching members has a terminal spring;

FIG. 14 is an axial (longitudinal) cross-sectional view showing an overall structure of a gas sensor according to a second embodiment of the present invention;

FIG. 15 an axial (longitudinal) cross-sectional view showing an overall structure of a gas sensor according to a third embodiment of the present invention and is an enlarged axial (longitudinal) sectional view showing the heater, the heater electrodes of the heater, and an electrode contact member according to the third embodiment of the present invention;

FIG. 16 is a perspective view showing the electrode contact member according to the third embodiment;

FIG. 17 is a cross-sectional view, taken on a line C-C in FIG. 15, showing the heater and the electrode contact member;

FIG. 18 an axial (longitudinal) cross-sectional view showing an overall structure of a gas sensor according to a modification of the third embodiment of the present invention and is an enlarged axial (longitudinal) sectional view showing the heater, the heater electrodes of the heater, and an electrode contact member having a contact section, wherein each of the heater electrodes of the heater is in contact with the electrode contact member at the contact section;

FIG. 19 is a perspective view showing the electrode contact member according to the modification of the third embodiment;

FIG. 20 is a cross-sectional view, taken on a line D-D in FIG. 18, showing the heater and the electrode contact member according to the modification of the third embodiment;

FIG. 21 is an axial (longitudinal) cross-sectional view showing an overall structure of a gas sensor according to a fourth embodiment of the present invention, wherein a heater is in contact with two pairs of electrode contact members at different levels in height inside an atmosphere-side insulator assembly;

FIG. 22 is an axial (longitudinal) cross-sectional view showing an overall structure of the gas sensor taken on line E-E of FIG. 21;

FIG. 23 is a perspective view showing the heater, a first and second electrode contact members;

FIG. 24 is a cross-sectional view, taken along a line F-F of FIG. 21, showing the heater, the atmosphere-side insulator assembly which is formed to be engaged by the plurality of atmosphere-side insulators the first electrode contact members, and the second electrode contact members; and

FIG. 25 is a cross-sectional view, taken along a line G-G of FIG. 22, showing the heater, the atmosphere-side insulator assembly which is formed to be engaged by the plurality of atmosphere-side insulators and the second electrode contact members.

### DESCRIPTION OF THE PREFERRED EMBODIMENTS

Preferred embodiments of a gas sensor according to the present invention will be explained below with reference to attached drawings. Identical sections are denoted by the same reference numerals throughout the drawings. The sensor will be exemplified by a gas sensor such as an oxygen sensor, an air-fuel ratio sensor, a NOₓ sensor, a CO sensor, a CO₂ sensor, and the like. Further, it will be appreciated that the gas sensor according to the present invention may be formed in a cup-shape or a bar-shape in which several layers are accumulated.

In the bar-shaped gas sensor having a sensor element, a heater, and a measurement gas side insulator, a housing, the heater is arranged to be inside the sensor element, and the sensor element is provided with a sensor electrode on a surface of a base end section. The housing holds the measurement gas side insulator that has a through-bore. The through-bore of the measurement gas side insulator holds the sensor element.

In general, the cup-shaped gas sensor has a housing made of a metal. Further, the housing has a though-bore through which the sensor element is inserted and by which the sensor element is held.

It should be noted that, for the sake of clarity and understanding, identical components having identical functions in the different embodiments of the invention have been marked with the same reference numerals in each of figures.

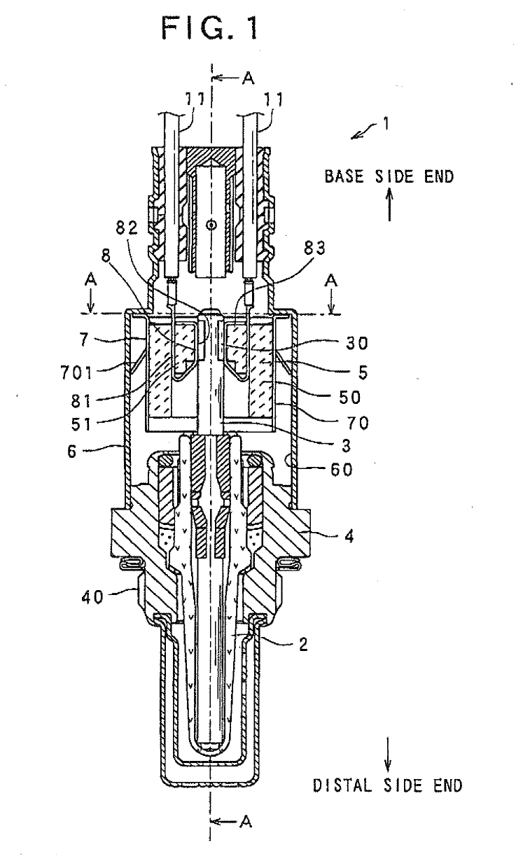

In the following embodiments and modifications, one side on which the gas sensor having a length is inserted into an exhaust an exhaust pipe or other devices is referred to as a “distal end side”, a “distal end” or a “measurement gas side”, while another side opposite to the one side along a longitudinal axis is referred to as a “base side end” or an “atmosphere side”. In addition, as shown in FIG. 1, a central axis “X” of the gas sensor is aligned with the longitudinal axis. Further, a radial axis is defined in a plane perpendicular to central axis “X” of the gas sensor.

### First Embodiment

Referring to FIGS. 1-13, a first embodiment of a gas sensor according to the present invention will be described.

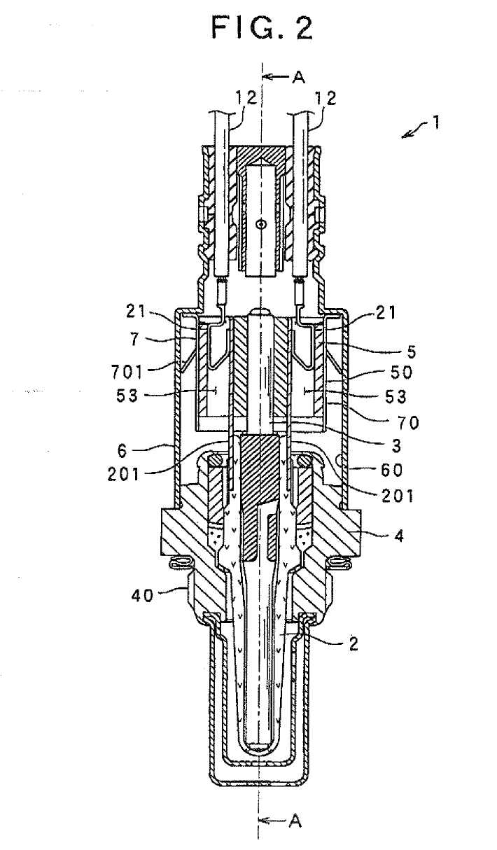

FIG. 1 is an axial (longitudinal) cross-sectional view showing an overall structure of the gas sensor according to the first embodiment of the present invention. FIG. 2 is an axial (longitudinal) cross-sectional view showing the overall structure of the gas sensor taken on line A-A of FIG. 1.

As shown in FIGS. 1 and 2, a gas sensor 1 according to the present embodiment includes a sensor element 2, a heater 3, a housing 4, an atmosphere side insulator assembly 5, and an atmosphere side cover 6. The gas sensor 1 has substantially a cylindrical shape and determines the concentration of a specific gas component contained in a measurement gas to be measured. The heater 3 heats up the sensor element 2. The heater 3 is surrounded by the sensor element 2 and has a heater electrode 30 on a peripheral surface of a base end section of the heater 3. The housing 4 has substantially cylindrical shape which defines a through hole and allows the sensor element 2 to be inserted into the through hole and held therein. Because the housing 4 serves as an element-holding body that holds the sensor element 2 therein, the housing 4 can be referred as to the element-holding body. The atmosphere side insulator assembly 5 is positioned beside a base end of the housing 4 along the central axis X of the gas sensor and covers a base end section of the heater 3 along the central axis X of the gas sensor. The atmosphere side cover 6 is disposed at a base end section of the housing 4 and has inner peripheral surface 60.

The sensor element 2 includes a solid electrolyte body, formed in a bottomed cylindrical shape. When the gas sensor 1 is an oxygen sensor or a nitrogen oxide sensor, the solid electrolyte body is made of an oxygen ion conducting material such as zirconia or the like. The solid electrolyte body has an inner peripheral surface and an outer peripheral surface, As shown in FIG. 2, on the inner peripheral surface of the solid electrolyte body, a first sensor electrode 201 is formed, while a second sensor electrode 203 is formed on the outer peripheral surface,

The heater 3 is formed in a cylindrical shape and is inserted into an inside of the sensor element 2 in mating engagement therewith.

The housing 4 has a screw portion 40 formed at a distal end thereof and threaded and fasten to an exhaust pipe through which the measurement gas to be measured by the gas sensor 1 flows. For example, when external vibration transmits to the exhaust pipe, the vibration is obliged to transmit to the inside of the gas sensor 1 through the housing 4. AS a result, the vibration finally transmits to the heater 4 and the atmosphere side insulator assembly 5,

As shown in FIG. 1-4, between the atmosphere side insulator assembly 5 and an inner peripheral surface of the atmosphere side cover 6, a holder is arranged to hold the atmosphere side insulator assembly 5. The holder 7 is at least partially made of a metal or other solid having elasticity.

The holder 7 has a pressing spring 701 formed on an outer peripheral surface 70 of the holder 7. The pressing spring 701 contacts to the inner peripheral surface 60 of the atmosphere side cover 6, and ensures to fix the atmosphere side insulator assembly 5 to an appropriate position inside the atmosphere side cover 6 so that the position of the atmosphere side insulator assembly 5 does not easily shift. Although detailed discussion will be given later, the holder has a slit aligned with the center axis X of the gas sensor, the slit defining edges 702 of the holder 7.

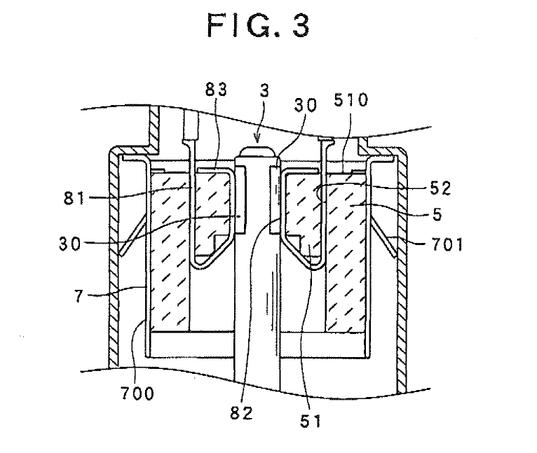

FIG. 3 is an enlarged partial cross-sectional view showing a supporting structure of the heater 3 and the atmosphere-side insulator assembly 5, the supporting structure including the heater 3, the atmosphere-side insulator assembly 5, electrode contact members 8, the holder 7, and the atmosphere-side cover 6.

The electrode contact members 8 contact with the heater electrode 30 of the heater 3.

Each of the electrode contact members 8 is formed, for example, into a single member comprised of a base plate section 81, an electrode section 82, and a locking section 83. The electrode section 82 of the electrode contact member 8 is abutted on the heater electrode 30 of the heater 3. The base plate section 81 is formed in a plate shape and is in contact to a first lead wire 11 through which electric power is supplied from an external electric power supply. Hence, electric current can conduct from the external electric power supply to the heater 3 via the first lead wire 11, the base plate section 81 of the electrode contact member 8, the heater electrode 30 of the heater 3.

In the present embodiment, none of electrode contact members 8 has elasticity so that the electrode contact members 8 cannot generate pressing force.

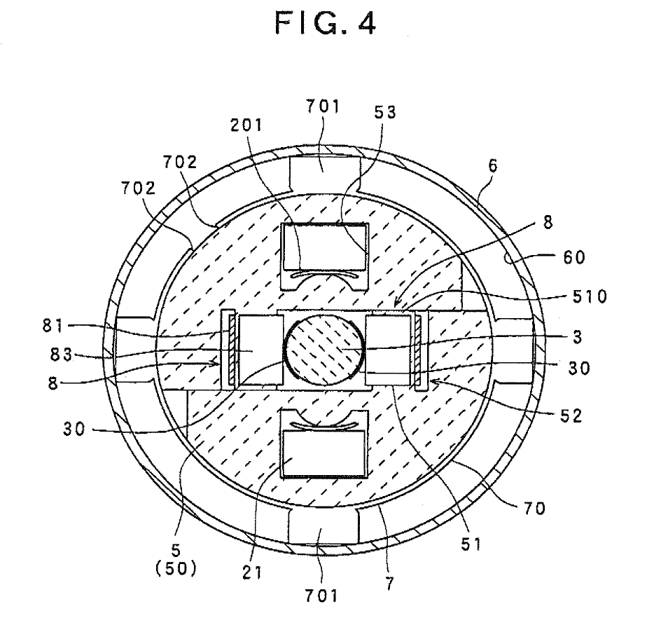

FIG. 4 is a cross-sectional view, taken along a planar direction perpendicular to a longitudinal direction of the gas sensor, showing the heater 3, the atmosphere-side insulator assembly 5 which is formed to be engaged by a plurality of atmosphere-side insulators 50 and the holder 7 that has the pressing spring 701 and partially surrounds the atmosphere-side insulator assembly 5, wherein the heater 3 is pressed by pressing force generated by the pressing spring 701 via the atmosphere-side insulators 50.

As can be seen in FIG. 4, the atmosphere-side insulator assembly 5 is constituted of the plurality of atmosphere-side insulators 50. In the gas sensor 1 according to the present embodiment, the atmosphere-side insulator assembly 5 is constituted of two atmosphere-side insulators 50. Each of the atmosphere-side insulators 50 has an electrode fixing portion 51. The electrode fixing portion 51 of the atmosphere-side insulator 50 is engaged with the electrode contact member 8 such that the locking section 83 of the electrode contact member 8 is locked on an base end surface 510 of the electrode fixing portion 51.

Further, the plurality of the atmosphere-side insulators 50 are engaged with each other due to elastic force generated by the pressing spring 701 of the holder 7. The elastic force generated by the holder 7 also ensures the electrode section 82 of the electrode contact member 8 to contact with the heater electrode 30 of the heater 3. In the present embodiment, the holder 7 has four pressing springs 701, and each of the pressing springs 701 is arranged in a position off by 90 degree from each other.

As shown in FIG. 4, the plurality of the atmosphere-side insulators 50 sandwiches and presses the heater 3 via the electrode fixing portion 51 of the atmosphere-side insulator 50 and the electrode contact members 8.

As shown in FIG. 2, the gas sensor 1 includes two terminal electrodes 21 which connect to a second lead wire 12. One of the terminal electrodes 21 electrically connects to the first sensor electrode 201, and the other one of the terminal electrodes 21 electrically connects to the second sensor electrode 203. Each of the terminal electrodes 21 is inserted into the through-hole 53 of the atmosphere-side insulator 50. Hence, electric current flows from the sensor element 2 and indicates the concentration of the specific gas component in the measurement gas, and flows to the second lead wire 12 via the terminal electrodes 21.

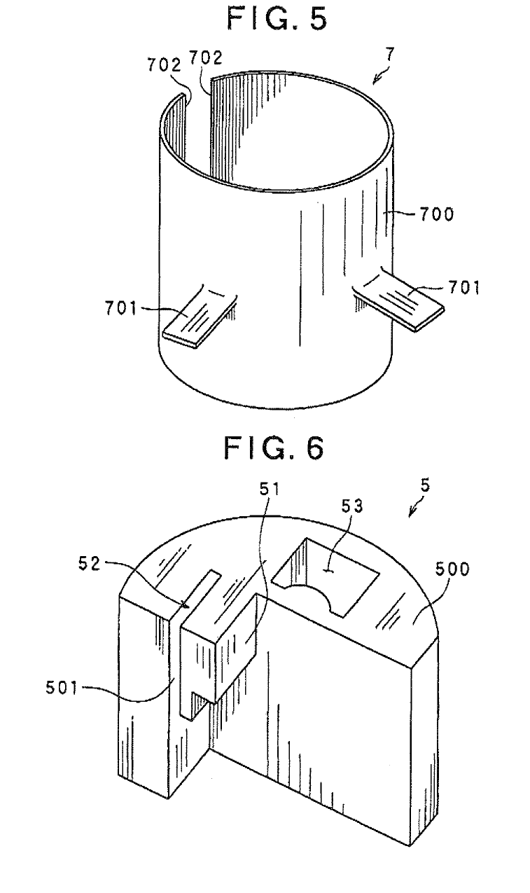

FIG. 5 is a perspective view showing the holder 7 that has the fixing spring 701 generating the pressing force towards the radial direction in a plane perpendicular to the longitudinal direction of the gas sensor 1.

As shown in FIG. 5, the holder 7 has substantially cylindrical shape and has the slit defining edges 702. The holder 7 has restoring force against an external force that tends to increase a diameter of the cylindrical shaped holder 7, that is, to increase a gap length between the edges 702. The restoring force of the holder 7 is applied to the plurality of the atmosphere-side insulators 50 to engage each other. As a result, the electrode contact members 8 are ensured to be in contact with the heater electrode 30 of the heater 3.

The fixing spring 701 is provided on the outer peripheral surface 700. The fixing spring 701 generates pressing force pressing the inner peripheral surface of the atmosphere side cover 6 by which the holder 7 and thus the atmosphere-side insulator assembly 5 held by the holder 7 is fixedly positioned inside the atmosphere side cover 6. In the present embodiment, the four fixing springs 701 are arranged at a middle position between the distal end and the base end of the holder 7. However, the number of the fixing springs 701 and positions at which the fixing springs 701 are arranged should not be limited to the case of the present embodiment because the pressing force can be adjusted to have an appropriate strength and direction by changing the number of the fixing springs 701 and/or the positions at which the fixing springs 701 to be arranged.

It should be noticed that the pressing force generated by the fixing springs 701 contributes to press the plurality of the atmosphere-side insulators 50 to engage each other so as to ensure the electrode contact members 8 to be in contact with the heater electrode 30 of the heater 3.

FIG. 6 is a perspective view showing one of the atmosphere-side insulators 50 having the electrode fixing portion 51 to which the electrode contact member 8 is fitted.

The electrode fixing portion 51 protrude from a first planar side surface of the atmosphere-side insulator 50 which has a substantially rectangular shape and is a cross section parallel to the center axis X of the gas sensor. A second planar side surface 501 is formed to orthogonally cross with the first planar side surface. The area of the first planar side surface is larger than that of the second planar side surface. A clearance 52 is formed between the second planar side surface 501 and the electrode fixing portion 51. The first planer side surface of the atmosphere-side insulator 50 serves as a stopper wall when two atmosphere-side insulators 50 are engaged to from the atmosphere-side insulator assembly 5 and to pinch the heater 3. The electrode fixing portion 51 of the atmosphere-side insulator 50 is engaged with the electrode contact member 8. In detail, the locking section 83 of the electrode contact member 8 is locked on the base end surface 510 of the electrode fixing portion 51. In other words, the electrode fixing portion 51 is surrounded by the base plate section 81, the electrode section 82, and the locking section 83 of the electrode contact member 8. Thus, the heater is surrounded by the electrode contact members 8 which are locked to the corresponding electrode fixing portions 51 of the atmosphere-side insulators 50 and the first planar side surfaces of the corresponding atmosphere-side insulators 50. Further, each of the atmosphere-side insulators 50 has a through-hole 53. The through-hole 53 communicates from the base end surface 510 of the insulator 50 to a distal end surface of the insulator 50.

As shown in FIG. 6, the clearance 52 is formed between the second planar side surface 501 crossing with the first planar side surface and the electrode fixing portion 51. This structure of the clearance 52 allows the base plate section 81 of the electrode contact member 8 to easily insert into the clearance 52. However, it is allowed that a further through-hole which communicates from the base side end surface of the insulator 50 to the distal side end surface of the insulator 50 replaces the clearance 52.

The terminal electrode 21 is inserted into the through hole 53, and the first sensor electrode 201 is sandwiched between one of sides of an inner wall defining the through hole 53 of the atmosphere-side insulator 50 and the terminal electrode 21, as shown in FIG. 2. In another atmosphere-side insulator 50, the second sensor electrode 203 is also sandwiched between one of sides of an inner wall defining the through hole 53 of the atmosphere-side insulator 50 and the terminal electrode 21.

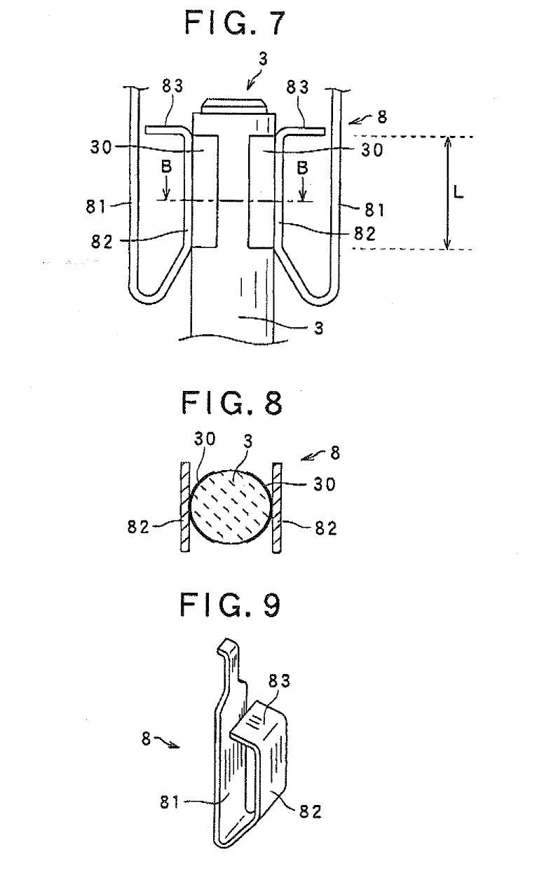

FIG. 7 is an enlarged axial (longitudinal) sectional view showing the heater 3, the heater electrode 30, and the electrode contact member 8, wherein each of the electrodes of the heater 30 is in contact with the electrode contact member 8 having a length L.

Specifically, each of the electrodes of the heater 30 is in contact with the electrode section 82.

FIG. 8 is a cross-sectional view, taken on a line B-B in FIG. 7, showing the heater 3 and the electrode contact member 8.

As shown in FIG. 8, the cross section of the electrode section 82 in a plane perpendicular to the center axis X of the gas sensor 1 has a rectangular shape, and that of the heater 3 has a circular shape. Hence, the heater 3 and the electrode contact member 8 are in contact with each other at a contact point in the plane. However, as shown in FIG. 7, along the center axis X of the gas sensor 1 the heater 3 and the electrode contact member 8 are in contact with each other along the length L. Thus, it is ensured that the heater 3 and the electrode contact member 8 are electrically connected.

FIG. 9 is a perspective view showing the electrode contact member 8.

In the present embodiment, all of the base plate section 81, the electrode section 82, and the locking section 83 of the electrode contact member 8 have substantially planar shapes.

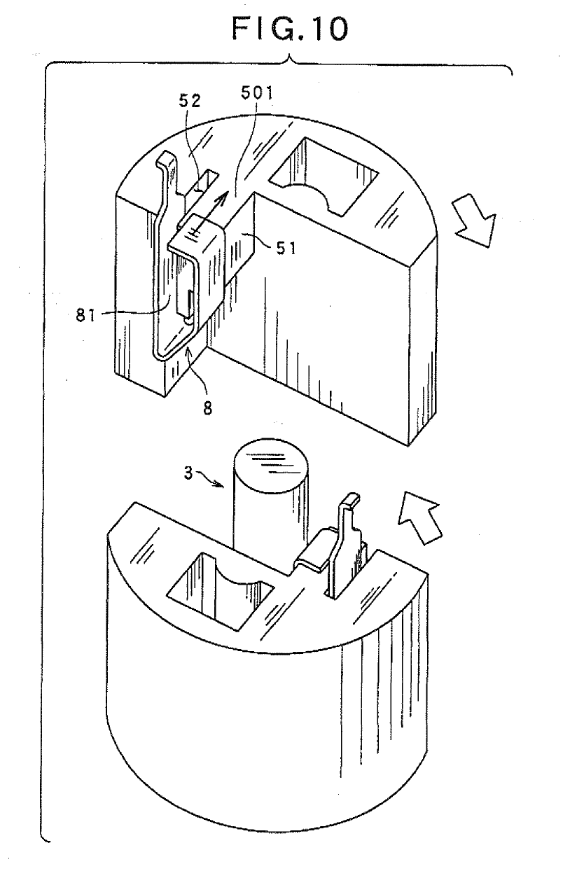

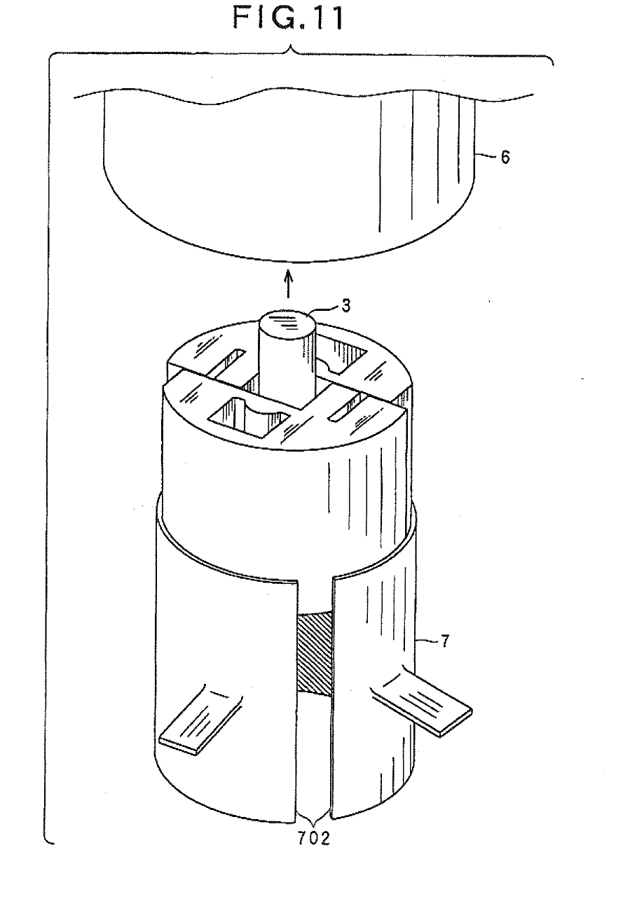

Referring to FIGS. 10 and 11, a method for assembly of the heater 3, the electrode contact members 8, the atmosphere-side insulators 50, the holder 7, and the atmosphere side cover 6 will be explained.

FIG. 10 is a perspective view showing steps of assembly of the heater 3, the holder 7, and the electrode contact member 8, wherein each of the electrode contact members 8 are fitted to the respective electrode fixing portion 51 of the corresponding atmosphere-side insulator 50, and the two atmosphere-side insulators 50 are engaged each other to form the atmosphere-side insulator assembly 5.

As shown in FIG. 10, at first, the electrode contact member 8 is engaged with the electrode fixing portion 51 of the atmosphere-side insulator 50. Specifically, the base plate section 81 of the electrode contact member 8 is inserted into the clearance 52 formed between the second planar side surface 501 crossing with the first planar side surface and the electrode fixing portion 51. As a result of this step, the locking section 83 of the electrode contact member 8 is locked on the base end surface 510 of the electrode fixing portion 51, and the electrode fixing portion 51 is surrounded by the base plate section 81, the electrode section 82, and the locking section 83 of the electrode contact member 8. In this step, the heater electrode 30 is to be in contact with the electrode section 82, and the terminal electrode 21 is to be inserted into the through hole 53 so as to be in contact with either the first sensor electrode 201. The same steps will be performed in another atmosphere-side insulator 50 except that instead of the first sensor electrode 201, second sensor electrode 203 will be used.

Next, such the two atmosphere-side insulators 50 each being provided with the electrode contact members 8 are prepared to hold the heater 3, as shown in FIG. 10, so that the atmosphere-side insulator assembly 5 holds the heater 3 therein. In this step, a side surface of the electrode fixing portion 51 of one of the two atmosphere-side insulators 50 touches the stopper wall of the another one of the two atmosphere-side insulators 50.

During combination of a plurality of the atmosphere-side insulators 50, the plurality of the atmosphere-side insulators 50 are needed to be approached to each others and to pinch the heater 3 in a direction along which the electrode sections 82 joined to the electrode fixing portions 51 face each other.

FIG. 11 is a perspective view showing steps of assembly of the atmosphere-side insulator assembly 5, the holder 7, and the atmosphere-side cover 6.

As shown in FIG. 11, the atmosphere-side insulator assembly 5 holding the heater 3 therein is inserted into the holder 7 while an external force to open the slit of the holder 7 defining the edges 702 is applied.

Next, the holder 7 is covered by the atmosphere-side cover 6 so that the atmosphere-side insulator assembly 5 is positioned inside the atmosphere-side cover 6. As a result, the atmosphere-side insulator assembly 5 is fixedly supported due to the pressure force generated by the fixing springs 701, and simultaneously the heater 3 is supported by the holder 7 via the atmosphere-side insulator assembly 5. So, in the course of assembly, the heater electrode 30 would not be damaged so that impairment of the gas sensor is prevented.

In the above mentioned processes of assembly, the heater 3 is pinched by the atmosphere-side insulators 50 before the atmosphere-side insulator assembly 5 is inserted into the holder 7. However, it is allowed that the heater is inserted into the atmosphere-side insulator assembly 5 after the atmosphere-side insulator assembly 5 is inserted into the holder 7.

In this case, the electrode contact member 8 is engaged with the electrode fixing portion 51 of the atmosphere-side insulator 50 so that the base end surface 510 of the electrode fixing portion 51 is hocked by the locking section 83 of the electrode contact member 8. Then, the two atmosphere-side insulators 50 are engaged to form the atmosphere-side insulator assembly 5 and are inserted into the holder 7 to be held by restoring force that is one of the characteristic physical properties of the holder 7 made of metal or the elastic material. Then, the atmosphere-side insulator assembly 5 is covered by the atmosphere-side cover 6 and is positioned inside the atmosphere-side cover 6 due to the pressure force generated by the fixing spring 701 of the holder 7. Then, the heater 3 is inserted into the atmosphere-side insulator assembly 5. These steps have advantages in which assembly can be performed easily, in particular, the step for engaging the atmosphere-side insulators 50 can be simplified.

In the present embodiment, the clearance 52 is formed between the second planar side surface 501 crossing with the first planar side surface and the electrode fixing portion 51. This structure of the clearance 52 allows the base plate section 81 of the electrode contact member 8 to easily insert into the clearance 52. Further, it is allowed that the base plate section 81 includes an additional section which has a complicated structure, for example, a connecting section for providing with a electric terminal, a second locking section 83 for locking the electrode fixing portion 51, and the like.

Further, it is allowed that the electrode fixing portion 51 is absent in the atmosphere-side insulator 50. In this case, a second through hole would be formed in the atmosphere-side insulator 50, and the electrode contact member 8 is inserted into the second through hole.

### Operations and Advantages of the Present Embodiment

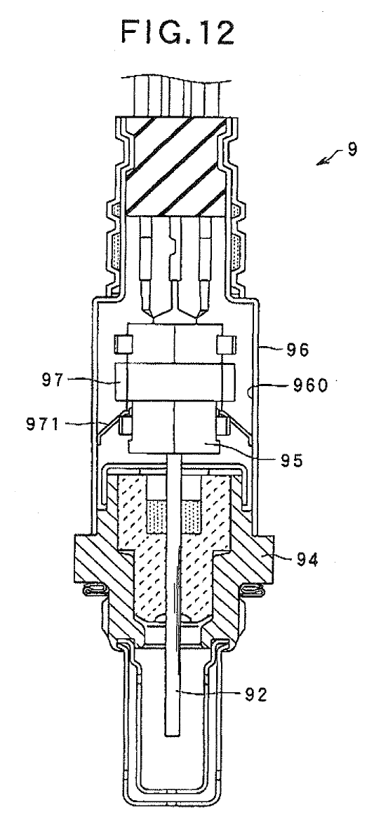

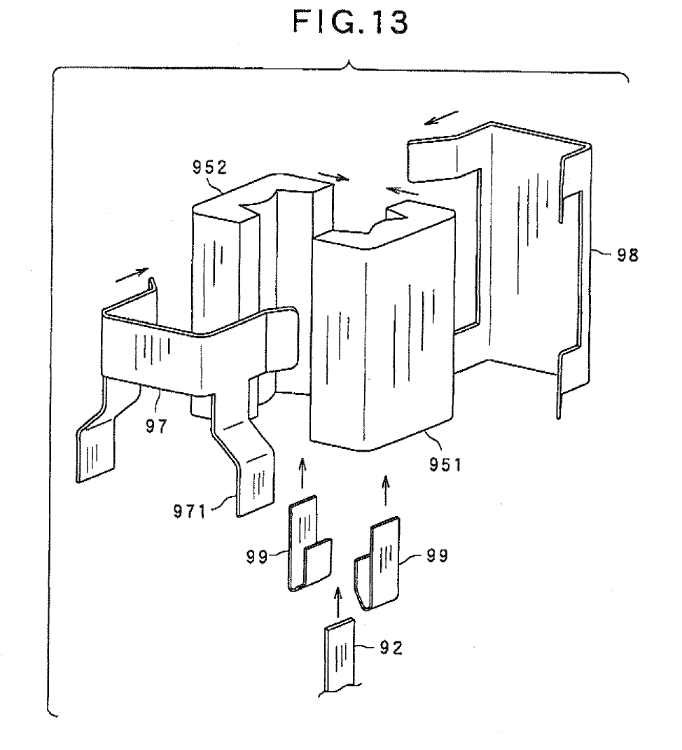

Referring to FIGS. 12 and 13, the operations and effects of the present embodiment will now be explained.

FIG. 12 is an axial (longitudinal) sectional view showing an overall structure of a comparative gas sensor 9.

FIG. 13 is a perspective view showing atmosphere-side insulators 951, 952, terminal springs 99, a heater 92, and pinching members 97, 98, wherein one of the pinching members 97 has a fixing piece 971.

The comparative gas sensor 9 comprises a sensor element that determines the concentration of a specific gas component contained in a measurement gas, the heater 92 that heats up the sensor element and surrounds the sensor element, a housing 94 which allows the sensor element to be inserted and held therein, a measurement gas side cover that is disposed at a distal end section of the housing to caver a distal end section of the sensor element in a longitudinal axis of the gas sensor, and an atmosphere side cover 96 that is jointed to a base end of the housing 94.

The gas sensor 9 is provided with an atmosphere side insulator assembly 95 that is disposed at a base end section of the housing 94 to cover a base end section of the heater 92. The atmosphere side insulator assembly 95 further comprises a plurality of the pinching members 951, 952 to cover and pinch a base end section of the heater 92 via terminal springs 99. The terminal spring 99 are positioned between the pinching members 951, 952 and the base end section of the heater 92, and fixes the base end section of the heater 92 inside the atmosphere side insulator assembly 95. The gas sensor 9 is further provided with the pressing spring 97 comprising a body 970 with which the atmosphere side insulator assembly 95 is bound and which holds and engages the pinching members 951, 952 to form the atmosphere side insulator assembly 95, and the fixing piece 971 which is formed at a distal end section of the body 970 of the pressing spring 97 and presses an inner peripheral surface 960 of the atmosphere side cover 96 to maintain the pinching members 951, 952 such that the base end section of the heater 92 is appropriately positioned inside the atmosphere side cover 96. The pressing spring 97 is made of a metal, a compound, or other solid which have elasticity. The fixing piece 971 of the pressing spring 97 generates a pressure force towards a radial direction in a plane perpendicular to the longitudinal axis of the gas sensor to press the inner peripheral surface of the atmosphere side cover 96 when the pressing spring 97 is positioned inside the atmosphere side cover 96 after the atmosphere side insulator assembly 95 and the pressing spring 97 are integrated. The pressing spring 97 ensures to fix the atmosphere side insulator assembly 95 to an appropriate position inside the atmosphere side cover 96.

Comparing to the gas sensor 1 with the comparative gas sensor 9, the plurality of the atmosphere side insulators 50 of the gas sensor 1 is bounded and engaged by pressing force generated by the fixing spring 701 of the holder 7 to form the atmosphere side insulator assembly 5. This configuration allows that the pressing force generated by the fixing spring 701 of the holder 7 ensures the electrode contact member 8 to be in contact with the heater electrode 30 of the heater 3. That is, the pressing force generated by the fixing spring 701 of the holder 7 is applied to the atmosphere side insulator assembly 5 via the holder 7 in the direction along which the electrode sections 82 joined to the electrode fixing portions 51 pinch and hold the heater 3. Thus, when the number of the fixing springs 701 and positions at which the fixing springs 701 to be arranged so that the pressing force is adjusted to have an appropriate strength and direction by changing the number of the fixing springs 701 and/or the positions at which the fixing springs 701 to be arranged, it would be possible to ensure the electrode contact member 8 to be in contact with the heater electrode 30 of the heater 3 and to fix the atmosphere side insulator assembly 5 to an appropriate position inside the atmosphere side cover 6 without any complicated structures of the constituents of the gas sensor 1.

Further, the electrode contact member 8 in the gas sensor 1 has been formed to generate no restoring force. Hence, it is allowed that the electrode contact member 8 can be made of a material having no elasticity. Thus, the electrode contact member 8 has a cost advantage in comparison with the terminal springs 99 of the gas sensor 9 which has a plurality of springs made of a material having elasticity such as metal. Therefore, the gas sensor 1 has a cost advantage in comparison with the gas sensor 9.

Further, the electrode contact member 8 and the heater electrode 30 of the heater 3 are bounded by the pressing force generated by the fixing springs 701 of the holder 7. Hence, it is possible to realize a simple force network in supporting structure of the heater 3 inside the atmosphere side cover 6.

In a manufacturing process of the gas sensor 1, the heater 3 is easily integrated with the atmosphere side insulator assembly 5.

As mentioned above, in the gas sensor 1, the pressing force generated by the fixing spring 701 of the holder 7 only used to bind and press the atmosphere side insulators 50 to ensure the electrode contact member 8 to be in contact with the heater electrode 30 of the heater 3. This leads to allow various forms of the electrode section 82 of the electrode contact member 8 which are in contact with the heater electrode 30. For example, the form of the electrode section 82 is deformed such that a contact area between the electrode section 82 and the heater electrode 30 is increased. In another example, the electrode section 82 is deformed to have a curvature so as to prevent the electrode section 82 from slipping on the heater electrode 30. So, the electrode contact member 8 is reliably in contact with the heater electrode 30.

Further, the electrode contact member 8 in the gas sensor 1 has been formed to generate no restoring force, During insertion of the heater 3 into the atmosphere side insulator assembly 5 to be in contact with the electrode contact member 8, no wear of the heater electrode 30 and a surface of the electrode contact member 8 may occur. As a result, the electrode contact member 8 is reliably in contact with the heater electrode 30.

In the gas sensor 1 according to the present embodiment, the atmosphere-side insulator assembly 5 is constituted of the two atmosphere-side insulators 50, so that two atmosphere-side insulators 50 are easily bounded or engaged with each other. This facilitates the ease of installation of the atmosphere-side insulator assembly 5 in the gas sensor 1.

Therefore, according to the present embodiment, it is possible to obtain the gas sensor 1 having the holder 7 in which the electrode contact member 8 is ensured to be in contact with the heater electrode 30 of the heater 3.

Further, there is provided the method for assembly of the constituents of the gas sensor 1 in which the heater electrode 30 is damaged so that impairment of the gas sensor is improved.

### Second Embodiment

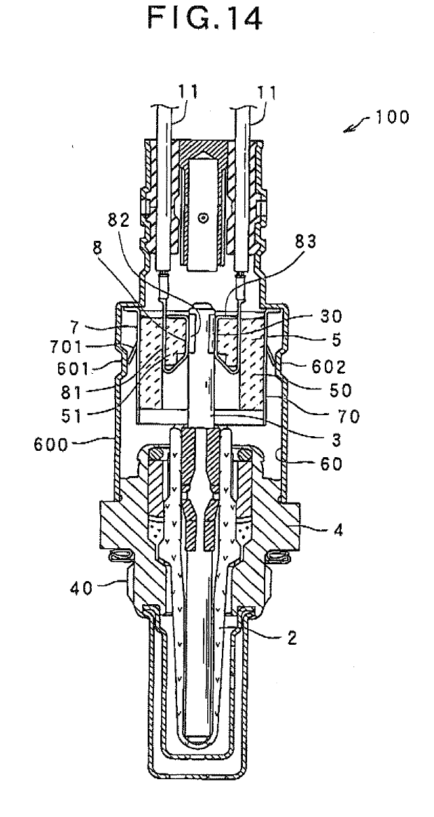

Referring to FIG. 14, a gas sensor 100 according to a second embodiment of the present invention will be described.

In the second embodiment, the only difference from the first embodiment is based on a shape of the atmosphere side cover 6. Thus, detailed discussion about the constituents of the gas sensor having the same function and the structure with those used in the first embodiment will be omitted.

FIG. 14 is an axial (longitudinal) cross-sectional view showing an overall structure of the gas sensor 100 according to the second embodiment of the present invention. The gas sensor 100 according to the present embodiment includes an atmosphere side cover 600, while the gas sensor 1 according to the first embodiment includes the atmosphere side cover 6, as shown in FIGS. 1 and 2.

As shown in FIG. 14, the atmosphere side cover 600 according to the present embodiment has a projection portion 602 formed on the inner peripheral surface 60 of the atmosphere side cover 600 on which an end of the fixing spring 701 of the holder touches. The atmosphere side cover 600 has substantially cylindrical shape. The projection portion 602 protrudes from the inner peripheral surface 60 of the atmosphere side cover 600 so that a diameter of the inner peripheral surface 60 is locally decreased in the projection portion 602. The projection portion 602 is formed by crimping.

During assembly, the electrode contact member 8 is engaged with the electrode fixing portion 51 of the atmosphere-side insulator 50 so that the locking section 83 of the electrode contact member 8 is locked on the base end surface 510 of the electrode fixing portion 51. Then, such the two atmosphere-side insulators 50 are engaged to form the atmosphere-side insulator assembly 5 and are inserted into the holder 7 to be held by restoring force that is one of the characteristic physical properties of the holder 7 made of metal or the elastic material. Then, the atmosphere-side insulator assembly 5 is covered by the atmosphere-side cover 600 and is positioned inside the atmosphere-side cover 600 due to the pressure force generated by the fixing spring 701 of the holder 7. Then, the heater 3 is inserted into the atmosphere-side insulator assembly 5 to be contact with the electrode contact member 8. Then, the atmosphere-side cover 600 is crimped from an outside of the atmosphere-side cover 600 to form the projection portion 602. This results in a increased strength of pressing force of the fixing springs 701 of the holder 7.

As a result, according to the gas sensor 100, it is possible to easily carry out a step in which the atmosphere-side insulator assembly 5 is covered by the atmosphere-side cover 600 and is positioned inside the atmosphere-side cover 600 due to the pressure force generated by the fixing spring 701 of the holder 7 because pressing force of the fixing springs 701 has not been increased.

After the atmosphere-side cover 600 is crimped from an outside of the atmosphere-side cover 600 to form the projection portion 60, it is possible to obtain the gas sensor 100 having the holder 7 in which the electrode contact member 8 is ensured to be in contact with the heater electrode 30 of the heater 3.

Further, there is provided the method for assembly of the constituents of the gas sensor 100 in which the heater electrode 30 is damaged so that impairment of the gas sensor is prevented.

Therefore, in the gas sensor 100 according to the second embodiment, the same advantages with the first embodiment can be obtained.

### Third Embodiment

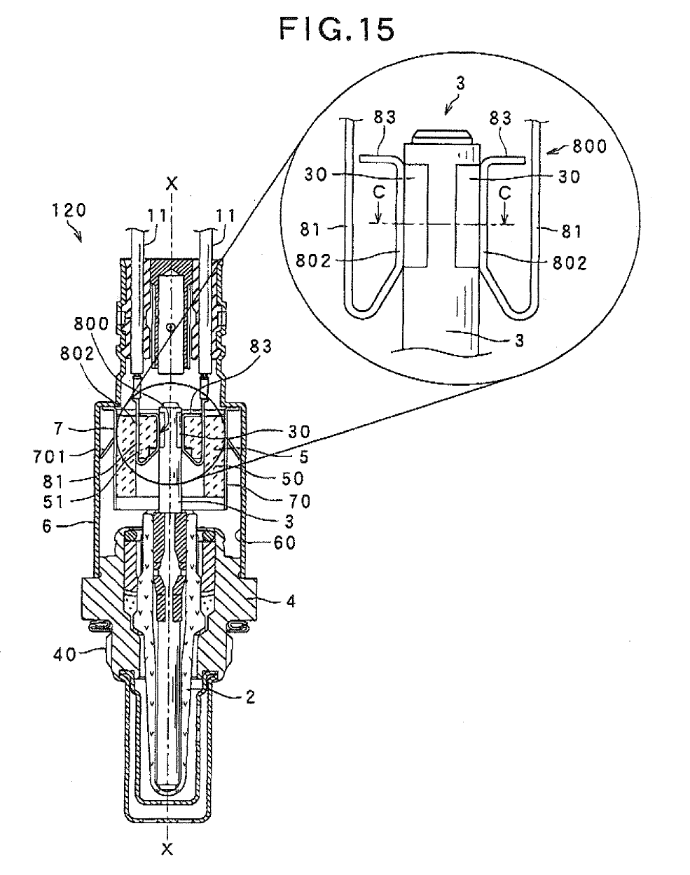

Referring to FIGS. 15-17, a gas sensor 120 according to a third embodiment of the present invention will be described.

In the third embodiment, the only difference from the previous embodiments is based on a shape of the electrode contact members 8. Thus, detailed discussion about the constituents of the gas sensor having the same function and the structure with those used in the first embodiment will be omitted.

FIG. 15 is an axial (longitudinal) cross-sectional view showing an overall structure of a gas sensor according to a third embodiment of the present invention and an enlarged axial (longitudinal) sectional view showing the heater, the heater electrodes, and an electrode contact member.

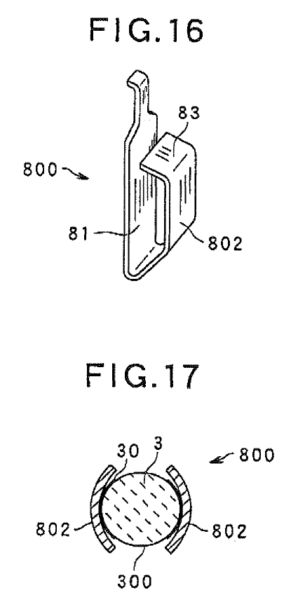

FIG. 16 is a perspective view showing an electrode contact member 800 according to the third embodiment.

As shown in FIGS. 15 and 16, the electrode contact member 800 of the gas sensor 120 includes the base plate section 81, an electrode section 802, and the locking section 83. The heater electrodes 30 are in contact with the electrode section 802 of the electrode contact member 800. The longitudinal cross-sectional view of the electrode contact member 800 has the same form with that of the electrode contact member 8 according to the previous embodiments. The difference of the electrode contact member 800 from the electrode contact member 8 can be seen in a cross-sectional view taken on a line C-C in FIG. 15.

FIG. 17 is a cross-sectional view, taken on the line C-C in FIG. 15, showing the heater 3 and the electrode contact member 800.

As shown in FIG. 17, the electrode section 802 of the electrode contact member 800 has a curvature in a plane perpendicular to the center axis X of the gas sensor. With the curvature of the outer peripheral surface 300 of the heater 3 in a plane perpendicular to the center axis X of the gas sensor being a first curvature R₁, and the curvature of the electrode section 802 being a second curvature R₂ , the first curvature of the outer peripheral surface 300 R₁ and the second curvature of the electrode section 802 R₂ satisfy the following relation;

R₂≧R₁.

Owing to such the structure of the electrode section 802, it is possible to prevent the electrode contact member 800 from moving along the outer peripheral surface 300. Because the heater electrode 30 is formed on the outer peripheral surface 300, it is further possible to reduce the heater electrode 30 from wearing due to position shift of the electrode section 802.

Therefore, it is possible to obtain the gas sensor 120 having the holder 7 in which the electrode contact member 800 is ensured to be in contact with the heater electrode 30 of the heater 3.

Further, in the gas sensor 120 according to the third embodiment, the same advantages with the previous embodiments can be obtained.

### Modification

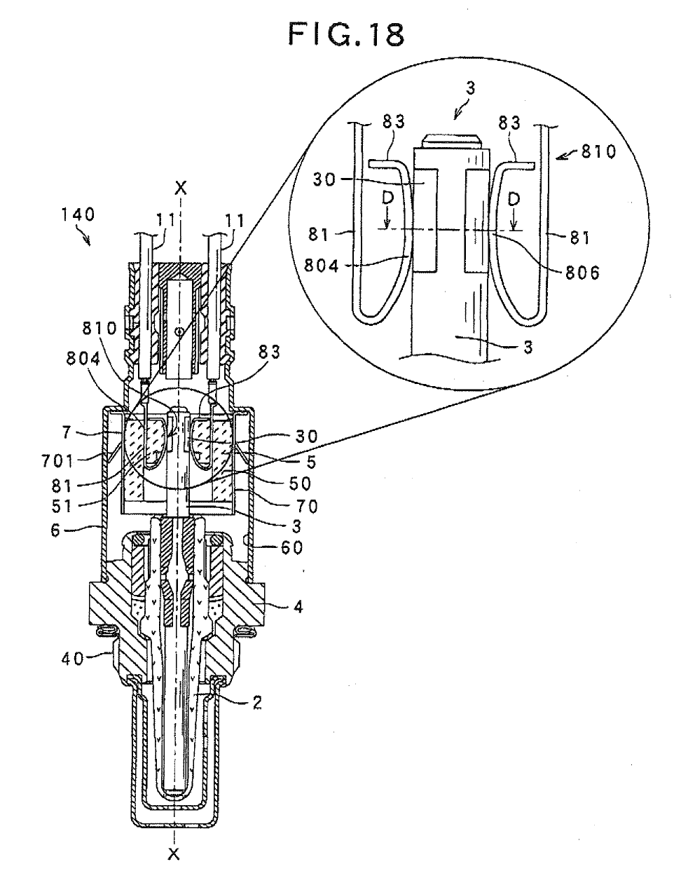

Referring to FIGS. 18-20, a gas sensor 140 according to a modification of the third embodiment of the present invention will be described.

In the modification of the third embodiment, the only difference from the third embodiment is based on a shape of the electrode contact members 800. Thus, detailed discussion about the constituents of the gas sensor having the same function and the structure with those used in the first embodiment will be omitted.

FIG. 18 an axial (longitudinal) cross-sectional view showing an overall structure of a gas sensor 140 according to a modification of the third embodiment of the present invention and is an enlarged axial (longitudinal) sectional view showing the heater 3, the heater electrodes 30, and an electrode contact member 810.

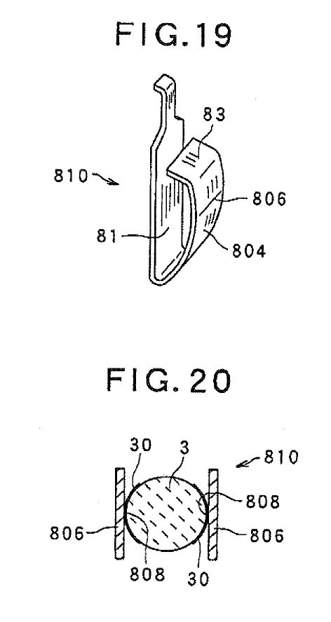

FIG. 19 is a perspective view showing the electrode contact member 810 according to the modification of the third embodiment.

As shown in FIGS. 18 and 19, the electrode contact member 810 of the gas sensor 140 includes the base plate section 81, an electrode section 804, and the locking section 83. The electrode section 804 has a different longitudinal cross-sectional view from the previous embodiments, that is, the electrode section 804 has a contact section 806 between ends of the electrode section 804 and is slightly bent from a plate so that the contact section 806 has the largest distance from the base plate section 81 in the electrode section 804 along the radial axis.

FIG. 20 is a cross-sectional view taken on a line D-D in FIG. 18, showing the heater 3 and the electrode contact member 810 according to the modification of the third embodiment

As shown in FIG. 20, the heater electrode 30 is in contact with the electrode contact member 810 at a surface 808 of the contact section 806.

Therefore, it is possible to obtain the gas sensor 140 having the holder 7 in which the electrode contact member 810 is ensured to be in contact with the heater electrode 30 of the heater 3.

Further, in the gas sensor 140 according to the third embodiment, the same advantages with the previous embodiments can be obtained.

### Fourth Embodiment

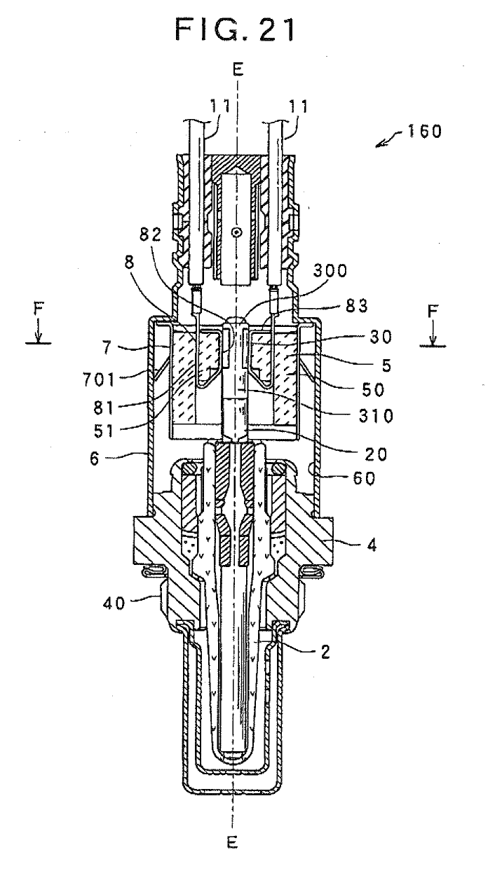

Referring to FIGS. 21-25, a gas sensor 160 according to a fourth embodiment of the present invention will be described.

In the fourth embodiment, the only difference from the previous embodiments is based on a supporting structure of a heater 3. The heater 3 is held by electrode contact member 8 to which pressing force generated by the pressing spring 701 is applied via the holder 7 and the atmosphere-side insulators 50 in the previous embodiments. Thus, the heater 3 is supported only at a first periphery where the heater electrodes 30 of the heater 3 are formed. However, in the gas sensor 160 according to the present embodiment, an elongated heater 310 has sensor pads 20 on the peripheral surface 300 thereof, and is supported not only at the first periphery where the heater electrodes 30 of the heater 310 are formed, but also at a second periphery where the sensor pads 20 are formed. The second periphery is located to have a distance from the base end of the heater 310 which is different from that of the heater electrode 30. Thus, the heater 310 is supported at a plurality of peripheries thereof. In the following, detailed discussion about the constituents of the gas sensor having the same function and the structure with those used in the first embodiment will be omitted.

FIG. 21 is an axial (longitudinal) cross-sectional view showing an overall structure of the gas sensor 160 according to the fourth embodiment of the present invention, wherein the heater 310 is in contact with two pairs of electrode contact members, that is, first electrode members 8 and second electrode members 850, at different levels in height inside an atmosphere-side insulator assembly 5.

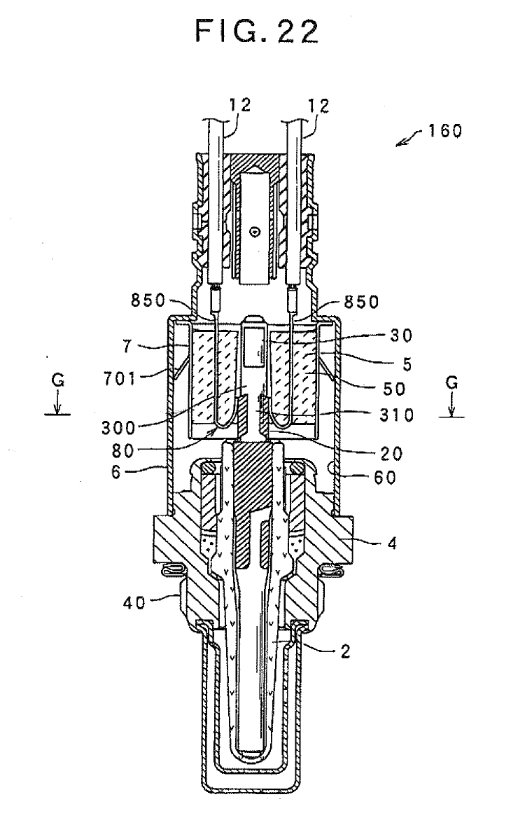

FIG. 22 is an axial (longitudinal) cross-sectional view showing the overall structure of the gas sensor 160 taken on line E-E of FIG. 21.

As shown in FIGS. 21 and 22, the gas sensor 160 according to the present embodiment includes the sensor element 2, the heater 310, the housing 4, the atmosphere side insulator assembly 5, and the atmosphere side cover 6. The gas sensor 1 has substantially a cylindrical shape and determines the concentration of a specific gas component contained in a measurement gas to be measured. The heater 3 heats up the sensor element 2. The heater 3 is surrounded by the sensor element 2 and has heater electrodes 30 on the peripheral surface 300 of the base end section of the heater 3. The housing 4 has substantially cylindrical shape which defines the through hole and allowed the sensor element 2 to be inserted into the through hole and held therein. The atmosphere side insulator assembly 5 is positioned beside the base end of the housing 4 along the central axis X of the gas sensor and covers the base end section of the heater 310 along the central axis X of the gas sensor. The atmosphere side cover 6 is disposed at the base end section of the housing 4 and has inner peripheral surface 60.

As shown in FIG. 21, the first electrode contact members 8 contact with the heater electrode 30 of the heater 310 at the base end section of the heater 3.

As shown in FIG. 22, the second electrode contact members 800 also contact with the sensor pads 20 of the heater 310 near a distal end section of the atmosphere side insulator assembly 5. The second electrode contact members 850 are connected to the second lead wire 12. Further, one of the second electrode contact members 850 electrically connects to the first sensor electrode 201, and the other one of the second electrode contact members 850 electrically connects to the second sensor electrode 203.

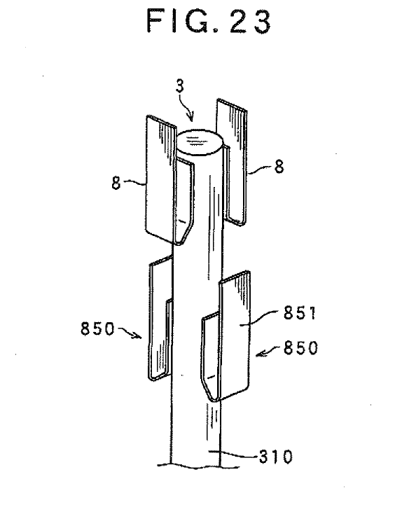

FIG. 23 is a perspective view showing the heater 310, the first electrode contact members 8, and the second electrode contact members 850.

As shown in FIG. 23, the heater 310 is supported at two peripheries by the first electrode contact members 8 and the second electrode contact members 850. One of the heater electrodes 30 and any one of the sensor pads 20 are arranged in a position off by 90 degree from each other in a plane perpendicular to a longitudinal axis of the heater 310.

As in the case where the first electrode contact members 8 has the base plate section 81, the electrode section 82, and the locking section 83, the second electrode contact members 850 has a base plate section 851 and an electrode section 852. The electrode section 802 is in contact with the sensor pad 20.

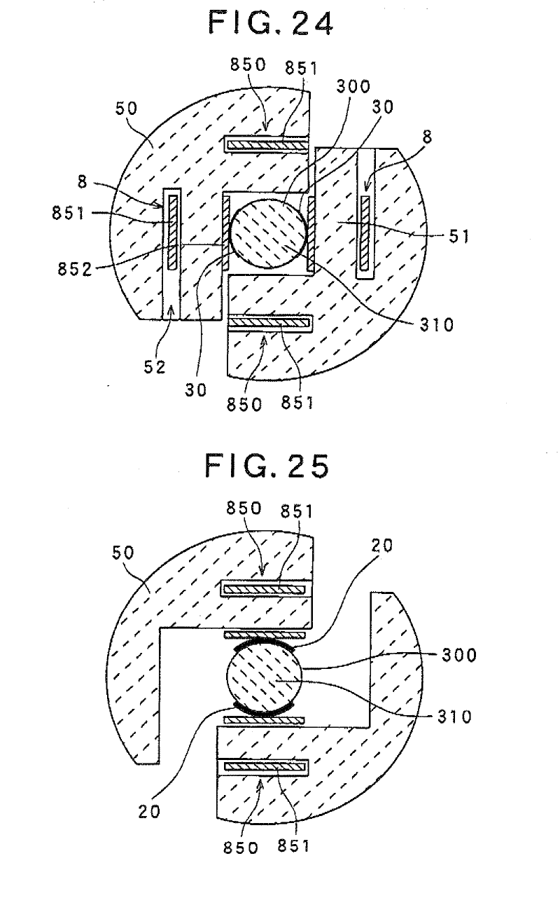

FIG. 24 is a cross-sectional view, taken along a line F-F of FIG. 21, showing the heater 310, the atmosphere-side insulator assembly 5 which is formed to be engaged by the plurality of atmosphere-side insulators 50, the first electrode contact members 8, and the second electrode contact members 850.

FIG. 25 is a cross-sectional view, taken along a line G-G of FIG. 22, showing the heater 310, the atmosphere-side insulator assembly 5 which is formed to be engaged by the plurality of atmosphere-side insulators 50 and the second electrode contact members 80.

As shown in FIGS. 24 and 25, in the present embodiment, pressing force generated by the pressing spring 701 of the holder 7 is applied to the heater 310 via the first electrode contact members 8 and the second electrode contact members 800. The first electrode contact members 8 and the second electrode contact members 800 are in contact with the different peripheries of the heater 310 from each other. Hence, the heater 301 is fixedly held by the atmosphere-side insulator assembly 5. Further, even if the gas sensor 160 receives vibration from the outside, it is possible to prevent the heater 310 from vibrating so that electric connections between the first electrode contact members 8 and the heater electrode 30 and between the second electrode contact members 800 and the sensor pads 20 are not broken. Simultaneously, wear of the heater electrode 30 and the sensor pads 20 are reduced.

Therefore, it is possible to obtain the gas sensor 160 having the holder 7 in which the first electrode contact member 8 is ensured to be in contact with the heater electrode 30 of the heater 3 and the second electrode contact members 800 is ensured to be in contact with the sensor pads 20.

Further, in the gas sensor 160 according to the fourth embodiment, the same advantages with the previous embodiments can be obtained.

### Modifications

Although the invention has been described above by reference to several embodiments of the invention, the invention is not limited to the embodiments described above. Modifications and variations of the embodiments described above will occur.

Foe example, in all the embodiments discussed above, the pressing spring 701 is formed on the holder 7. However, it is allowed that the pressing spring 701 is formed on the inner peripheral surface 60 of the atmosphere side cover 6.

Further, it is allowed that the pressing spring 701 is replaced by an elastic member that generates the pressing force.

In this case, a gas sensor has a base end and a distal end opposite to the base end along a center axis X of the gas sensor, and has the sensor element 2, a heater 3, the housing 4, the atmosphere-side insulator assembly 5, the electric terminal member 8, the atmosphere-side cover 6, the holder 7, and the elastic member 701 which is separately provided from the holder 7. The sensor element 2 produces a signal indicating a concentration of a gas. The heater 3 heats up the sensor element 2. The heater 3 has a length having a base end nearer to the base end of the gas sensor than the distal end of the gas sensor along the center axis X of the gas sensor. The heater 3 further comprises a base end section that is located near the base of the heater and an electrode 30 that is disposed on an peripheral surface of the base end section. The housing 4 has a base end nearer to the base end of the gas sensor than the distal end of the gas sensor and a through-hole in which the sensor element is held. The insulator assembly 5 surrounds the base section of the heater 3 and is constituted of a plurality of the atmosphere-side insulators 50. The electric terminal member 8 is located between the one of the plurality of the insulators and the electrode of the heater 3. The cover 6 covers the atmosphere-side insulator assembly 5 and has an inner wall surface. The holder 7 is configured to hold the atmosphere-side insulator assembly 5 and is arranged between the atmosphere-side insulator assembly 5 and the atmosphere-side cover 6. The elastic member 701 is located between the holder 7 and the inner wall surface of the atmosphere-side cover 6 to generate elastic force which is applied at least to the one of the plurality of the insulators 50 to pinch the heater 3 between the one of the one of the plurality of the atmosphere-side insulators 50 and another one of the plurality of the atmosphere-side insulators 50 via the holder 7 so as to bring the electric terminal member 701 into constant electric contact with the electrode 30 of the heater.

Therefore, Thus, when the number of the elastic members 701 and positions at which the elastic members 701 to be arranged so that the pressing force is adjusted to have an appropriate strength and direction by changing the number of the elastic members 701 and/or the positions at which the elastic members 701 to be arranged, the electrode 30 of the heater 3 is ensured to be in contact with the electric terminal member 8 and to fix the atmosphere-side insulator assembly 5 to an appropriate position inside the atmosphere-side cover 6 without any complicated structures of the constituents of the gas sensor.

What is claimed is:

1. A gas sensor having a base end and a distal end opposite to the base end along a center axis of the gas sensor, comprising:
a sensor element that produces a signal indicating a concentration of a gas;
a heater that heats up the sensor element and has a length having a base end nearer to the base end of the gas sensor than the distal end of the gas sensor along the center axis of the gas sensor, comprising:
a base end section that is located near the base of the heater; and
an electrode that is disposed on an peripheral surface of the base end section;
a housing that has a base end nearer to the base end of the gas sensor than the distal end of the gas sensor and a through-hole in which the sensor element is held;
an insulator assembly that surrounds the base section of the heater and is constituted of a plurality of insulators;
an electric terminal member that is located between one of the plurality of the insulators and the electrode of the heater;
a cover that covers the insulator assembly and has an inner wall surface;
a holder for holding the insulator assembly, the holder being arranged between the insulator assembly and the cover; and
an elastic member that is located between the holder and the inner wall surface of the cover to generate elastic force which is applied at least to the one of the plurality of the insulators to pinch the heater between the one of the plurality of the insulators and another one of the plurality of the insulators via the holder so as to bring the electric terminal member into constant electric contact with the electrode of the heater.

2. The gas sensor according to claim 1, wherein the elastic member is joined to the holder.

3. The gas sensor according to claim 2, wherein the elastic member is a spring integrally formed on the holder.

4. The gas sensor according to claim 3, wherein the insulator assembly is composed of two insulators.

5. The gas sensor according to claim 3, further comprising:
the electric terminal member generates no elasticity.

6. The gas sensor according to claim 1, wherein
the cover further comprises an interior projection section that is inwardly projected from the inner wall surface of the cover at a position to which spring is touched to apply the elastic force to press the inner wall surface of the cover.

7. The gas sensor according to claim 3, wherein the cover further comprises an interior projection section that is inwardly projected from the inner wall surface of the cover at a position to which spring is touched to apply the elastic force to press the inner wall surface of the cover,

8. The gas sensor according to claim 1, wherein
the insulator assembly has a length, and
the heater is in contact with the insulator assembly at a plurality of points positioned on a plurality of peripheries having different length from the base end of the heater each others.

9. The gas sensor according to claim 3, wherein
the insulator assembly has a length, and
the heater is in contact with the insulator assembly at a plurality of points positioned on a plurality of peripheries having different length from the base end of the heater each others.

10. The gas sensor according to claim 1, wherein
the insulator assembly is composed of two insulators,
one of the plurality of the insulators has a stopper wall and a projecting section to which the electric terminal member is locked so as to bring one of surfaces of the electric terminal to be in contact into with the heater, so that the one of the surfaces of the electric terminal and the stopper wall being in contact with the heater, and
another of the plurality of the insulators has a pinching surface and a stopper wall, the pinching surface and the stopper wall being in contact with the heater, and
the elastic force has a component thereof which is applied in a direction parallel to both the stopper surfaces of the one of the plurality of the insulators and the another one of the plurality of the insulators to form the insulator assembly from the one of the plurality of the insulators and the another one of the plurality of the insulators and to pinch the heater, so that the heater is pinched between the one of the surface of the electric terminal locked to the one of the plurality of the insulators and the pinching surface of the another one of the plurality of the insulators.

11. The gas sensor according to claim 3, wherein
one of the plurality of the insulators has a stopper wall and a projecting section to which the electric terminal member is locked so as to bring one of surfaces of the electric terminal to be in contact into with the heater, so that the one of the surfaces of the electric terminal and the stopper wall being in contact with the heater, and
another of the plurality of the insulators has a pinching surface and a stopper wall, the pinching surface and the stopper wall being in contact with the heater, and
the elastic force has a component thereof which is applied in a direction parallel to both the stopper surfaces of the one of the plurality of the insulators and the another one of the plurality of the insulators to form the insulator assembly from the one of the plurality of the insulators and the another one of the plurality of the insulators and to pinch the heater, so that the heater is pinched between the one of the surface of the electric terminal locked to the one of the plurality of the insulators and the pinching surface of the another one of the plurality of the insulators.

12. A gas sensor having a base end and a distal end opposite to the base end along a center axis of the gas sensor, comprising:
a sensor element that produces a signal indicating a concentration of a gas;
a heater that heats up the sensor element and has a length having a base end nearer to the base end of the gas sensor than the distal end of the gas sensor along the center axis of the gas sensor, comprising:
a base end section that is located near the base of the heater; and
an electrode that is disposed on an peripheral surface of the base end section;
a housing that has a base end nearer to the base end of the gas sensor than the distal end of the gas sensor and a through-hole in which the sensor element is held;
an insulator assembly that surrounds the base section of the heater and is constituted of a plurality of insulators;
an electric terminal member that is located between the one of the plurality of the insulators and the electrode of the heater;
a cover that covers the insulator assembly and has an inner wall surface;
a holder arranged between the insulator assembly and the inner wall surface of the cover, further comprising:
means for holding the insulator assembly;
means for generating elastic force which is applied at least to the one of the plurality of the insulators to pinch the heater between the one of the one of the plurality of the insulators and another one of the plurality of the insulators via the holder so as to bring the electric terminal member into constant electric contact with the electrode of the heater.

13. The gas sensor according to claim 12, wherein
the insulator assembly is composed of two insulators,
one of the plurality of the insulators has a stopper wall and a projecting section to which the electric terminal member is locked so as to bring one of surfaces of the electric terminal to be in contact into with the heater, so that the one of the surfaces of the electric terminal and the stopper wall being in contact with the heater, and
another of the plurality of the insulators has a pinching surface and a stopper wall, the pinching surface and the stopper wall being in contact with the heater, and
the elastic force has a component thereof which is applied in a direction parallel to both the stopper surfaces of the one of the plurality of the insulators and the another one of the plurality of the insulators to form the insulator assembly from the one of the plurality of the insulators and the another one of the plurality of the insulators and to pinch the heater, so that the heater is pinched between the one of the surface of the electric terminal locked to the one of the plurality of the insulators and the pinching surface of the another one of the plurality of the insulators.

14. The gas sensor according to claim 12, wherein
the holder has an insulator holding portion having a substantially cylindrical shape having a slit along the center axis of the gas sensor, and a spring which is formed on a outer surface of the insulator holding portion serving as the means for generating elastic force.
